(19) United States
(12) Patent Application Publication
(10) Pub. No.: US 2010/0271949 A1
(43) Pub. Date: Oct. 28, 2010

(54) Traffic processing system and method of processing traffic

(75) Inventors: Han Jun Yoon, Daejeon (KR); Chang Ki Kim, Daejeon (KR); Cheol Hye Cho, Daejeon (KR); Young Jick Bahg, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignees: Samsung Electronics Co., Ltd., Suwon-Si, Gyeonggi-Do (KR); Electronics and Telecommunications Research Institute, Daejeon (KR)

(21) Appl. No.: 12/747,332

(22) PCT Filed: Jul. 29, 2008
(86) PCT No.: PCT/KR08/04417

§ 371 Date: Jun. 10, 2010

(30) Foreign Application Priority Data
Dec. 10, 2007 (KR) 10-2007-0127459

(51) Int. Cl. H04L 12/26

(52) U.S. Cl. 370/235

(57) ABSTRACT

Enclosed is traffic processing system and a method of processing traffic. A plurality of apparatuses for processing traffic are provided to disperse traffic for mobile terminals, to prevent the bottle neck phenomenon of the traffic, to effectively process the traffic, and to rapidly use the services of the mobile terminals.

### TECHNICAL FIELD

The present invention relates to a traffic processing system and a method of processing traffic, and more particularly, to a traffic processing system capable of improving the performance of a system by rapidly assigning IPs to a mobile terminal and by dispersing traffic and a method of processing traffic.

This work was partly supported by the IT R & D program of MIC/IITA [2005-S-404-23, '3G Evolution Access System Development].

### BACKGROUND ART

Recently, a radio communication system supports IP based services on a wide band radio communication network to provide the IP based services to a mobile terminal.

Such a radio communication system is improved from a conventional network to guarantee a low delay rate and a high data transmission rate. In the radio communication system, a packet switched network is used instead of a conventional circuit switched network in which the efficiency of network resources deteriorates so that a packet data network (PDN) can be easily connected to a user terminal.

The system includes a mobile terminal, a radio connection network to which the mobile terminal is connected, a core network, a home subscriber server, and a policy charging rule function (PCRF).

In the above-described system, a traffic processing apparatus for performing the functions of a gateway of providing a connection point to an IP network and of transmitting service traffic transmitted to the mobile terminal to the radio connection network is provided in the core network.

In the above-described system, resources are wasted due to the generation of paging that is not required for the traffic processing apparatus to transmit a filtered jacket. In addition, since the traffic caused by a plurality of connection nodes using services is processed by one traffic processing apparatus, a bottle neck phenomenon is generated so that the performance of the system may deteriorate.

### DISCLOSURE OF INVENTION

### Technical Problem

In order to solve the above-described problems, it is an object of the present invention to provide a traffic processing system including a plurality of traffic processing apparatuses in order to provide a high band width to the system to reduce the generation of unnecessary paging and capable of effectively assigning IPs and dispersing traffic to rapidly process the traffic so that the performance of the system improves and a method of processing the traffic.

### Technical Solution

In order to solve the problems, a traffic processing system connected to a radio connection network comprising a plurality of evolved nodes to which mobile terminals are connected to process traffic for the mobile terminals comprises mobility managing apparatuses connected to the plurality of evolved nodes to manage mobility and connection information on the mobile terminals, a plurality of system architecture gateways for assigning IPs to the mobile terminals in accordance with request of the mobility managing apparatuses and for transmitting data packets for the mobile terminals, and a load balance unit for transmitting data packets received from an IP network to one of the plurality of system architecture gateways.

In addition, a method of processing traffic of a traffic processing system comprises system architecture gateways initializing IP address storage spaces using interface IDs and IP prefix information for the mobile terminals, receiving address assignment request for the mobile terminals from mobility managing apparatuses, and assigning IP addresses to the mobile terminals using the interface IDs and the IP prefix information and transmitting the IP addresses to the mobility managing apparatuses.

In addition, a method of processing traffic of a traffic processing system comprises, when a first data packet of a mobile terminal is transmitted to an IP network by a first system gateway among a plurality of system architecture gateways, a load balance unit storing information on the first data packet and, when a second data packet is received from the IP network to the mobile terminal in response to the first data pack, transmitting the second data packet to the first system gateway in accordance with the stored information.

### Advantageous Effects

In the traffic processing system according to the present invention and the method of processing the traffic, the generation of paging for the mobile terminal is minimized to reduce overload caused by the unnecessary paging and to save the process resources of the system, IPs are effectively assigned to the mobile terminal so that the mobile terminal can be rapidly connected to the IP network, and the traffic is dispersed so that traffic processing speed is improved to provide high speed traffic and to improve the performance of the system.

### BRIEF DESCRIPTION OF THE DRAWINGS

FIG. 1 illustrates the structure of a radio communication network to which a traffic processing system for processing the traffic of a mobile terminal according to an embodiment of the present invention is connected;

FIG. 2 is a block diagram illustrating the structure of a traffic processing system according to a first embodiment of the present invention;

FIG. 3 is a block diagram illustrating the structure of a traffic processing system according to a second embodiment of the present invention;

FIG. 4 illustrates the flows of control signals and traffic using a plurality of system architecture evolution gateways (SAE GW) according to an embodiment of the present invention;

FIG. 5 illustrates the operations of an SAE GW of managing and assigning IPs according to an embodiment of the present invention; and

FIG. 6 is a flowchart illustrating the operations of a method of processing a packet for paging in an SAE GW according to an embodiment of the present invention.

### BEST MODE FOR CARRYING OUT THE INVENTION

Hereinafter, embodiments of the present invention will be described with reference to the accompanying drawings.

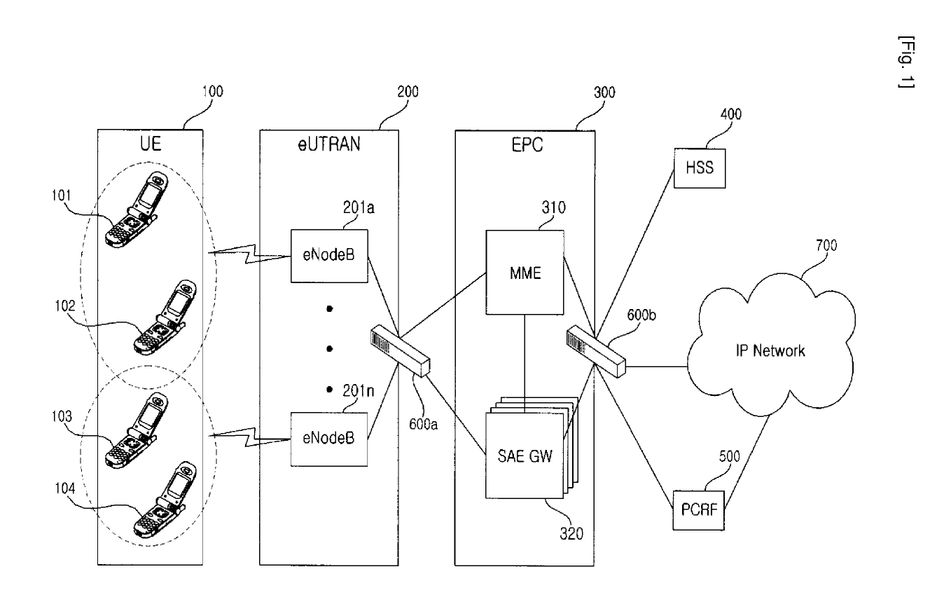

FIG. 1 illustrates the structure of a radio communication network to which a traffic processing system for processing the traffic of a mobile terminal according to an embodiment of the present invention is connected.

Referring to FIG. 1, the traffic processing system according to the present invention is an evolved packet core (EPC) 300 connected to an evolved universal mobile telecommunications network terrestrial radio access network (EUTRAN) 200 to which a mobile terminal UE 100 is connected to connect the mobile terminal UE 100 to an external IP based packet network or a conventional communication network and enables the mobile terminal UE to use IP based services.

In addition, the traffic processing system is connected to a home subscriber server (HSS) 400 and a policy charging rule function (PCRF) 500 to register, to authenticate, and to verify the rights of a subscriber and is connected to an IP network 700 to provide the IP based services to the mobile terminal UE 100. At this time, the PCRF 500 provides information of guaranteeing QoS for radio resources between the mobile terminal UE 100 and the EUTRAN 200 and information of setting a downlink traffic flow template (DL-TFT) in the EPC 300.

At this time, switches 600a and 600b for switching signals can be further included between the EUTRAN 200 and the EPC 300 and the EPC 300 and the IP network 700.

The mobile terminal UE 100 can use IP based multimedia services such as voice, image, position confirmation, and instant message services. Any terminal that satisfies the performance requirements of the traffic processing system can be used as the mobile terminal UE 100. For example, one of a mobile telephone, a notebook, a personal digital assistant (PDA), and an ultra-mobile PC (UMPC) can be used as the mobile terminal.

The EUTRAN 200 includes a plurality of evolved nodes eNodeB 210a to 210n.

The plurality of evolved nodes eNodeB 210a to 210n receive upper link signals transmitted from a physical layer level to the mobile terminal UE 100 to transmit the received upper link signals to the EPC 300 and to transmit lower link signals from the EPC 300 to the mobile terminal UE 100.

That is, the plurality of evolved nodes eNodeB 210a to 210n transmit signals to and receive signals from the mobile terminal UE 100 to function as an access point for connecting the mobile terminal UE 100 to the EUTRAN 200. In addition, the evolved nodes eNodeB 210a to 210n manage radio resources in units of cells to constitute the mobile terminal UE 100 and a radio channel in a corresponding cell and to have the mobile terminal UE 100 and a radio channel in a corresponding cell communicate with each other and to assign radio resources to and to release radio resources from the mobile terminal UE 100.

The EPC 300 as the traffic processing system includes a mobility management entity (MME) 310 and a plurality of system architecture evolution gateways (SAE GW) 320.

In addition, the EPC 300 further includes a gateway managing unit 330 for processing signals between the MME 310 and the plurality of SAE GWs 320 and a load balance unit 340 for dispersing traffic from the IP network 700 to the plurality of SAE GWs 320 to transmit the dispersed traffic to a predetermined SAE GW 320.

At this time, the gateway managing unit 320 and the load balance unit 340 apply data to be transmitted to one of the plurality of SAE GWs to disperse data so that corresponding data is processed by a predetermined SAE GW.

The MME 310 is connected to the plurality of evolved nodes eNodeB 210a to 210n of the EUTRAN 200 to manage the mobility and the access information of the mobile terminal UE 100 and to transmit control messages to and to receive control messages from the evolved nodes eNodeB 210. In addition, the MME 310 controls a bearer and provides interface to the HSS 400 for authenticating the mobile terminal UE 100.

The SAE GWs 320 function as gateways for performing connection to the Internet or an external packet network. That is, the SAE GWs 320 function as connection points between a network and the IP network 700.

The SAE GWs 320 function as tunnels in accordance with the use of services of the mobile terminal UE 100, manage the generated tunnels, assign IPs to the mobile terminal UE 100, and function as anchors during local handovers between the evolved nodes eNodeB 210.

In addition, the SAE GWs 320 filter the packet received from the IP network 700 and transmit the filtered packet to the evolved nodes eNodeB 210 through the tunnels assigned to the mobile terminal UE 100 so that data is transmitted to the mobile terminal UE 100.

At this time, the SAE GWs 320 filter only the packet toward the mobile terminal UE 100 connected to a managed evolved node eNode B 210 among the user data received from the IP network 700 so that the filtered packet is transmitted to a proper SAE bearer.

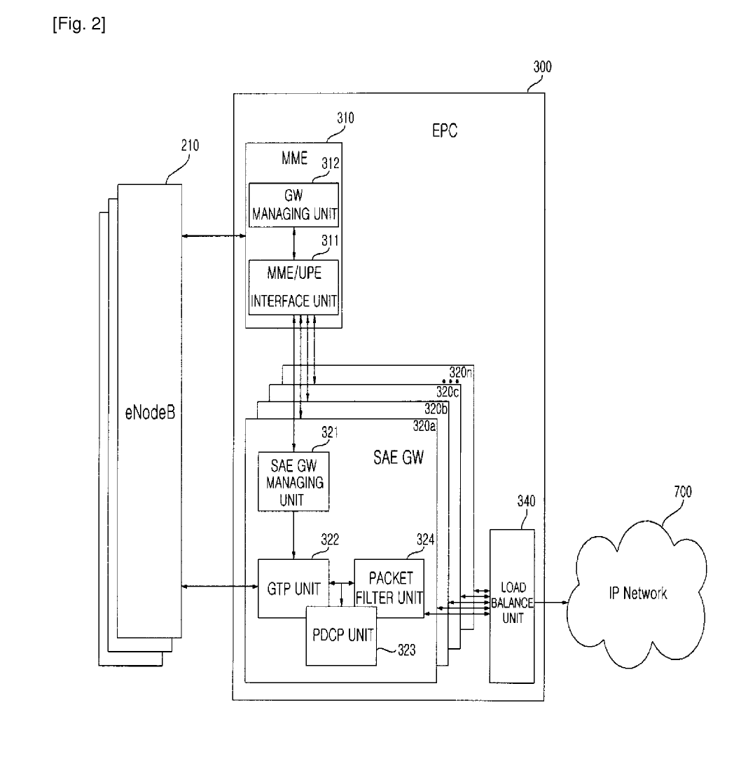

FIG. 2 is a block diagram illustrating the structure of a traffic processing system according to a first embodiment of the present invention.

Referring to FIG. 2, in the traffic processing system according to the first embodiment, as described above, the EPC 300 includes the MME 310, the plurality of SAE GWs 320, and the load balance unit 340. At this time, in the EPC 300, a gateway managing unit 312 is included in the MME 310. Here, in the EPC 300, the MME 310 and the SAE GWs 320 are provided in one apparatus. However, the present invention is not limited to the above but the MME 310 and the SAE GWs 320 can be provided in separate apparatuses.

The MME 310 includes an MME/UPE interface unit 311 and the gateway managing unit 312.

The MME/UPE interface unit 311 is an interface for performing data transmission between the MME 310 and the plurality of SAE GWs 320. The gateway managing unit 312 disperses and manages the data transmitted to the SAE GW 320 through the MME/UPE interface unit 311.

The gateway managing unit 312 selects one of the plurality of SAE GWs 320a to 320n, to which data is transmitted from the MME/UPE interface unit 311, so that traffic for the plurality of SAE GWs 320a to 320n is dispersed.

At this time, the gateway managing unit 312 transmits data to one SAE GW in accordance with the amount of traffic or the QoS information of the plurality of SAE GWs 320a to 320n so that the traffic is dispersed to the plurality of SAE GWs 320a to 320n. In addition, the gateway managing unit 312 stores and manages the information of the SAE GW 320 set by the transmitted data so that the plurality of SAE GWs 320a to 320n can logically operate like one SAE GW.

Each of the plurality of SAE GWs 320 includes a SAE GW managing unit 321, a GTP unit 322, a PDCP unit 323, and a packet filter 324. The SAE GWs 320 are connected to the evolved nodes eNodeB 210 to transmit the data to the IP network 700 and to transmit the data transmitted from the IP network 700 to the mobile terminal UE 100 to the evolved nodes eNodeB 210. At this time, the SAE GW 320 has an independent interface with the IP network 700, the evolved nodes eNodeB 210, and the MME 310.

The packet filter unit 324 as an interface with the IP network 700 intercepts packets from the IP network 700, performs packet routing and forwarding functions, analyzes the packets transmitted from the evolved nodes eNodeB 210, and transmits the analyzed packets to the IP network 700 or another terminal. At this time, the packet filter unit 324 manages packet filter tables in order to intercept the packets.

The packet filter unit 324 filters the packets transmitted to the mobile terminal UE 100, examines a set consisting of five components including a destination address, a dispatch place address, a destination port number, a dispatch place port number, and a protocol for all of the IP packets, and performs paging request by the matching information of a packet filtering function.

In addition, the packet filter unit 324 requests mobile terminals UE 100 in an idle state to perform paging for downlink packets and requests paging only for the packets matched in accordance with the matching information of the packet filtering function. At this time, the packet filter unit 324 requests paging for data packets in which IP prefix information matches addresses as a result of determination. This is because, since the packet filter tables for the mobile terminals in the idle state are deleted, when the packets for the idle mobile terminals UE 100 are determined by matching the packet filter tables, resources are wasted and unnecessary paging is generated. The IP prefix information is generated by the SAE GW managing unit 321 using an IP address managing space.

In addition, the packet filter unit 324 stores only the first packet among the data packets when the paging is requested and transmits the stored packet to the mobile terminal UE 100 when a bearer for the mobile terminal UE 100 is generated by the paging performed by the SAE GW managing unit 321 and the MME 310. At this time, since a large amount of process resources are used like in the case of table matching when all of the packets that match the IP prefixes of the mobile terminals UE 100 are stored to deteriorate the traffic processing performance of the SAE GW 320, the packet filter unit 324 stores only the first packet.

The GTP unit 322 as an interface with the evolved nodes eNodeB 210 generates user tunnels between the evolved nodes eNodeB 210 and the SAE GWs 320 and examines physical channels between the evolved nodes eNodeB 210 and the SAE GWs 320. In addition, the GTP unit 322 transmits captured packets to the evolved nodes eNodeB 210 through the tunnels generated as described above or receives the packets transmitted from the evolved nodes eNodeB 210.

The PDCP unit 323 as a radio protocol compresses headers for the IP packets so that radio resources can be effectively used.

The SAE GW managing unit 321 as an interface with the MME 310 is connected to the MME/UPE interface unit 311 to transmit data, to receive information for normally operating interfaces with the outside as described above from the MME 310, and to respond to the received information.

The SAE GW managing unit 321 initializes IP address storage spaces for the mobile terminals when the services of the mobile terminals UE 100 start and generates interface IDs and IP prefix information to be used for the mobile terminals UE 100. At this time, the SAE GW managing unit 321 assigns IPs to the mobile terminals UE 100 using the interface IDs and the IP prefix information when the MME 310 requests the mobile terminals UE 100 to assign addresses.

At this time, the SAE GW managing unit 321 assigns IP addresses using the interface IDs and the IP prefix information when the IP address storage space is initialized as described above not by a statefull IP address assigning method using DHCP or a stateless IP address assigning method using an RA message periodically generated by a router to rapidly assign the IP addresses to the mobile terminals UE 100.

Here, since data on the mobile terminals UE 100 are dispersed by the gateway managing unit 312 to the plurality of SAE GWs 320a to 320n, the number of evolved nodes eNodeB 210 and mobile terminals UE 100 that are managed by the SAE GW managing unit 321 in each of the SAE GWs 320 is reduced so that data can be rapidly processed.

The load balance unit 340 transmits the packets received from the IP network 700 to a predetermined SAE GW 320 among the plurality of SAE GWs 320a to 320n to disperse the traffic.

When data packets are transmitted from one of the plurality of SAE GWs 320a to 320n to the IP network 700, the load balance unit 340 stores information on the data packets and information on the SAE GW 320 by which the data packets are processed. When the packets are received from the IP network 700, the load balance unit 340 transmits the packets to the predetermined SAE GW 320 based on stored information to disperse the traffic.

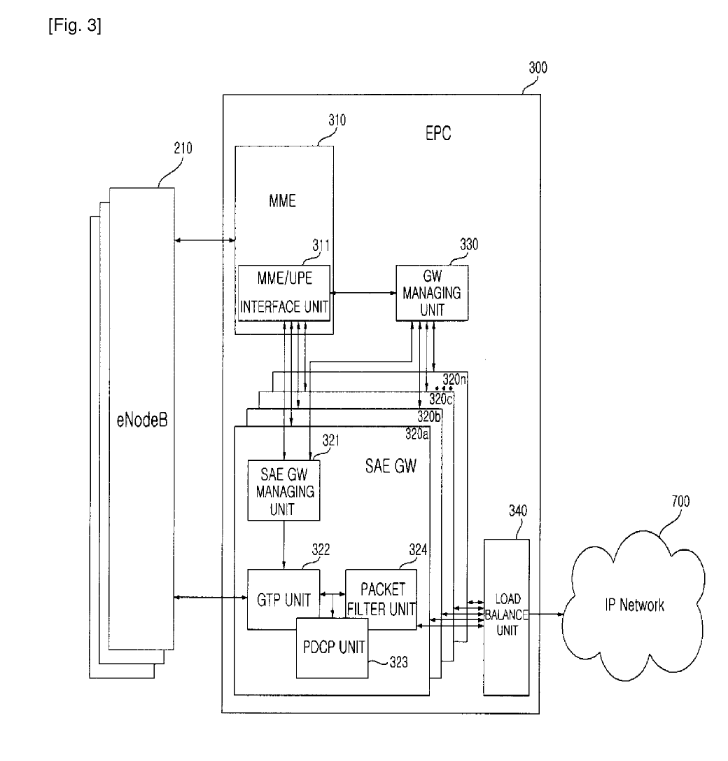

FIG. 3 is a block diagram illustrating the structure of a traffic processing system according to a second embodiment of the present invention.

Referring to FIG. 3, in the traffic processing system according to the second embodiment, like in the above-described traffic processing system according to the first embodiment, the EPC 300 includes the MME 310, the plurality of SAE GWs 320, and the load balance unit 340. In addition, in the traffic processing system according to the second embodiment, the EPC 300 further includes a gateway managing unit 330.

At this time, the structure of the EPC 300 according to the second embodiment is different from the structure of the EPC 300 according to the first embodiment in that the gateway managing unit 330 is additionally provided outside the MME 310. The other structures and operations of the EPC 300 according to the second embodiment are the same as those of the EPC 300 according to the first embodiment. Since the same components as the components of the first embodiment are denoted by the same reference numerals, description thereof will be omitted hereinafter.

The gateway managing unit 330 is connected to the MME/UPE interface unit 311 of the MME 310 and the SAE GW managing units 321 of the plurality of SAE GWs 320a to 320n to control the data transmitted from the MME/UPE interface unit 311 to the SAE GWs 320 to be transmitted to one of the plurality of SAE GWs 320a to 320n.

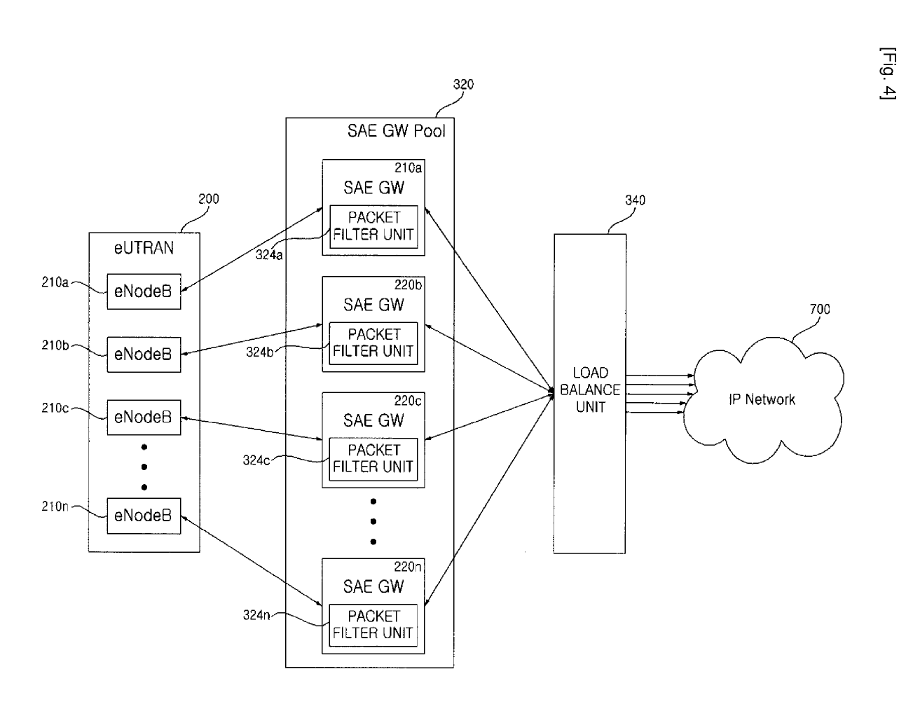

FIG. 4 illustrates the flows of control signals and traffic using a plurality of system architecture evolution gateways (SAE GW) according to an embodiment of the present invention.

Referring to FIG. 4, in the traffic processing system, the EPC 300 includes the plurality of SAE GWs 320a to 320n and disperses a large amount of traffic through the gateway managing units 312 and 330 and the load balance unit 340.

The plurality of SAE GWs 320a to 320n matches the IP network 700 through the pack filter units 324a to 324n to transmit and receive the data packets. The packet filter units 324a to 324n intercept the received data packets to apply the data packets to the GTP unit 322 through an SAE bearer 331 so that the data packets can be transmitted to the evolved nodes eNodeB 210.

At this time, as described above, the load balance unit 340 stores information on the data packets transmitted from the packet filter units 324a to 324n of the plurality of SAE GWs 320a to 320n to the IP network 700 and information on the SAE GWs 320 by which the corresponding data packets are processed so that, when responses to the transmitted packets are received from the IP network 700, the responses are transmitted to the predetermined SAE GW 320 in accordance with the stored information.

For example, when the packet data is transmitted to the IP network 700 through the first SAE GW 320a, the load balance unit 340 stores information on the transmitted packets and information on the first SAE GW 320a and, when the data packets having the same information are received from the IP network 700, transmits the corresponding data packets to the first SAE GW 320a in accordance with the previously stored information.

At this time, in the case of the data packets that are not transmitted from the SAE GWs 320 to the IP network 700, since information on the corresponding data packets does not exist, the load balance unit 340 transmits the corresponding data packets to a predetermined SAE GW 320 by a round robin method in the SAE GWs 320a to 320n to disperse the traffic.

The operations of the traffic processing system according to an embodiment of the present invention having the above structure will be described as follows.

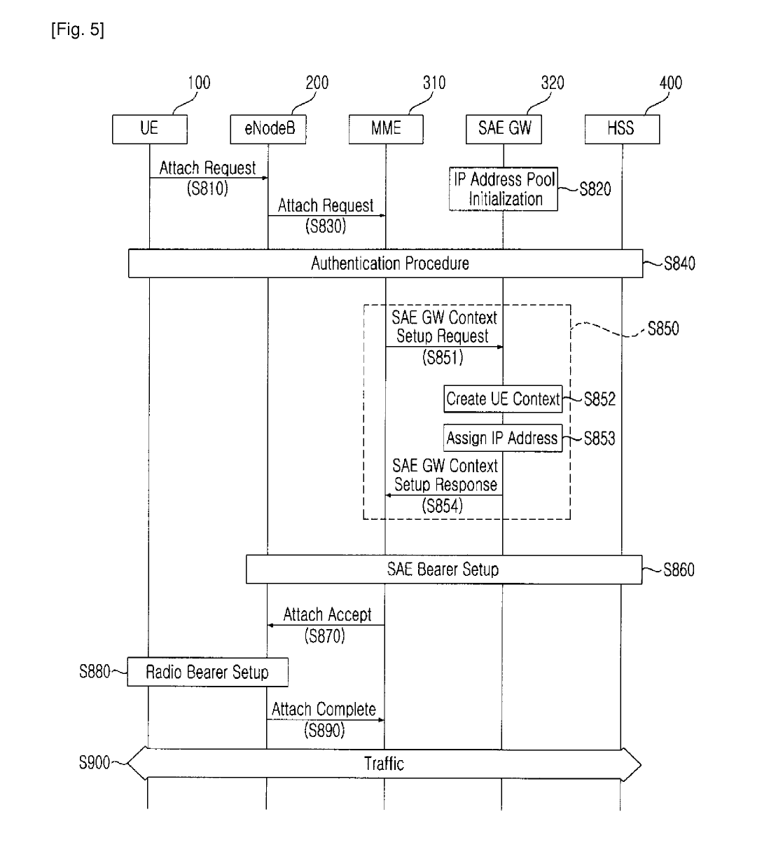

FIG. 5 illustrates the operations of an SAE GW of managing and assigning IPs according to an embodiment of the present invention.

Referring to FIG. 5, when the mobile terminal UE 100 is driven, the mobile terminal UE 100 is connected to one of the plurality of evolved nodes eNodeB 210a to 210n of the EUTRAN 200 to request connection (S810). The evolved nodes eNodeB 210 request the MME 310 of the EPC 300 that the mobile terminal UE 100 be connected in accordance with the request of the mobile terminal UE (S830).

The SAE GWs 320 initialize the storage spaces for managing the IP addresses of the mobile terminals UE 100 at the moment when the services of the mobile terminals start (S820). At this time, the SAE GWs 320 generate the interface Ids and the IP prefix information to be used by the mobile terminals UE 100 through a system manager or operations and management (O&M) so that the interface ID values of the mobile terminals UE 100 are set as unique values.

The MME 310 authenticates the mobile terminals UE 100 through communication with the HSS 400 in accordance with the request of the evolved nodes eNodeB 210 (S840) and requests the SAE GWs 320 to generate context and to assign the IP addresses (S851).

The SAE GWs 320 generate context for the mobile terminal UE 100 (S852) and assign the IP addresses (S853) to transmit a response to the setup request to the MME 310 (S854). At this time, the SAE GWs 320 transmit the interface IDs and the IP prefix information generated by the initialization process (S820).

At this time, in the above-described IP assigning process (S850), the gateway managing units 312 and 330 transmit context generation and IP address assignment request (S851) from the MME 310 to one of the SAE GWs 320 in accordance with the traffic amount or the QoS information of the plurality of SAE GWs 320a to 320n and transmit the responses (S854) of the SAE GWs 320 to the MME 310.

The SAE bearer is set from the evolved nodes eNodeB to the MME 310, the SAE GWs 320, and the HSS 400 by the SAE GWs 320 generating context by and assigning IPs to the mobile terminal UE 100.

The MME 310 transmits signals of allowing connection to the evolved nodes eNodeB 210 as responses to the connection request (S870). The evolved nodes eNodeB 210 set a radio bearer among the mobile terminals UE 100 (S880) to transmit signals for the connection completion to the MME 310 (S890).

Therefore, the mobile terminal UE 100 generates the SAE bearer and the radio bearer to use the IP based services through communication with the IP network 700.

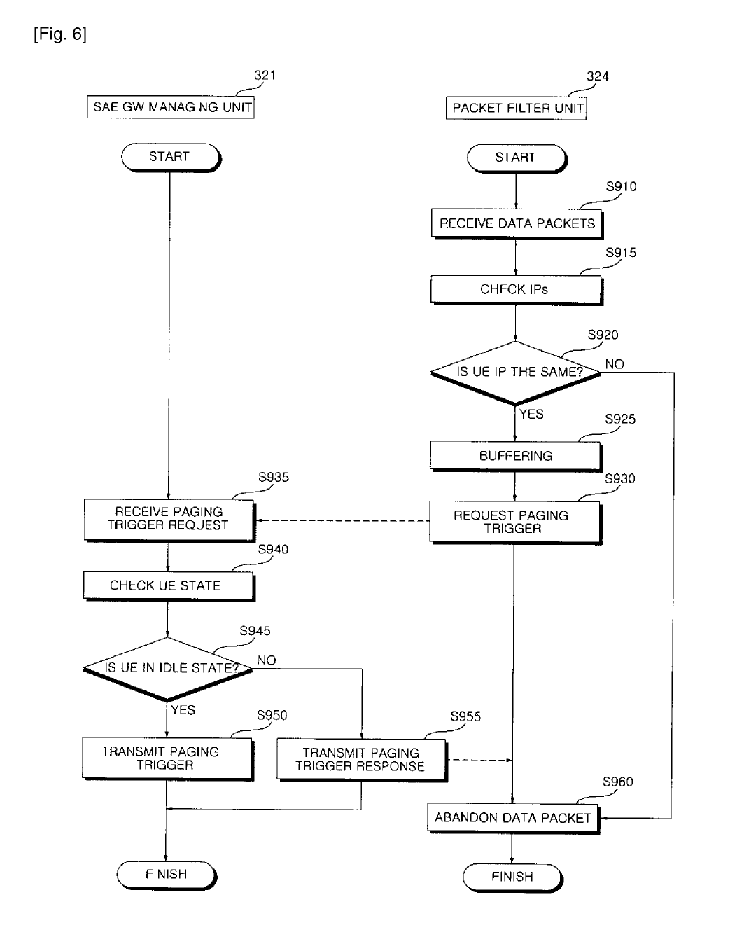

FIG. 6 is a flowchart illustrating the operations of a method of processing a packet for paging in an SAE GW according to an embodiment of the present invention.

Referring to FIG. 6, the data packets are received from the IP network 700 to the packet filter unit 324 of the SAE GW 320 (S910).

Here, the data packets received from the IP network 700 are transmitted to a predetermined SAE GW 320 among the plurality of SAE GW 320a to 320n through the load balance unit 340. At this time, when information on the data packets does not exist in the load balance unit 340, the data packets are transmitted to one of the SAE GWs 320 in accordance with the round robin method in the SAE GWs 320.

The packet filter unit 324 checks the IP addresses of the received data packets (S915). At this time, the mobile terminal UE 100 is in an idle state.

In FIG. 5, the packet filter unit 324 matches the IP prefix information during the setting of the IP addresses for the mobile terminal UE 100 (S853) or in the process of initializing the mobile terminal (S820) the IP addresses of the data packets to determine whether the IP addresses of the data packets are the same as the IP addresses of the mobile terminal UE 100 (S920).

The packet filter unit 324 buffers only the first packet among the data packets whose IP addresses match the IP prefix addresses in accordance with the initialization of the IP address management space (S925) and requests the SAE GW managing unit 312 to transmit a paging trigger (S930).

The data packets that do not match the IP prefix information of the mobile terminal

UE 100 are abandoned (S960).

Here, the packet filter unit 324 manages the packet filter tables in order to intercept the data packets. The filter tables for the mobile terminals in the idle states are deleted from the packet filter tables not to be applied. Therefore, the packet filter unit 324 does not intercept the packets by the table matching but compares the IP prefix information with the IP addresses of the data packets to determine whether the IP prefix information is the same as the IP addresses of the data packets and to prevent resources from being wasted and unnecessary paging from being generated by the table matching for the mobile terminals in the idle states whose packet filter tables do not exist.

When the paging trigger request of the packet filter unit 324 is received (S935), the SAE GW managing unit 321 checks the state of the mobile terminal UE 100 (S940). When the mobile terminal UE 100 is in the idle state, the paging trigger is transmitted to the MME 310 (S950).

At this time, after the paging request, the packet filter unit 324 stores only the first packet among the corresponding data packets. When the bearers for the mobile terminals UE 100 are generated by the paging processes performed by the SAE GW managing unit 321 and the MME 310, the stored packets are transmitted to the mobile terminals UE 100. Since a large amount of process resources are used like in the case of the table matching when all of the packets that match the IP prefix information of the mobile terminals UE 100 are stored in the above process to deteriorate the traffic processing performance of the SAE GW 320, the packet filter unit 324 stores only the first packet.

On the other hand, when the mobile terminal UE 100 is not in the idle state, the page trigger response is transmitted to the packet filter unit 324 (S955). At this time, the packet filter unit 324 abandons the data packets in accordance with the response from the SAE GW managing unit 321 (S960).

Therefore, in the traffic processing system according to the present invention and the method of processing the traffic, the plurality of SAE GWs are provided and the gateway managing units 312 and 330 and the load balance unit 340 are included so that a large amount of traffic is dispersed to rapidly assign the IPs, to easily process the traffic, and to increase traffic that can be processed.

In addition, since the table matching is not used but the matching of the IP addresses using the IP prefix information is used, it is possible to prevent unnecessary paging from being generated, to rapidly process the traffic, and to improve the performance of the system.

As described above, the traffic processing system according to the present invention and the method of processing the traffic have been described with reference to the embodiment shown in the drawings, these are merely illustrative, and those skilled in the art will understand that various modifications and equivalent other embodiments of the present invention are possible. Consequently, the true technical protective scope of the present invention must be determined based on the technical spirit of the appended claims.

In the traffic processing system and the method of processing the traffic, in processing the traffic for the mobile terminal, the plurality of apparatuses for processing the traffic are provided so that it is possible to effectively assign the IPs to the mobile terminals, to disperse the traffic, to minimize the generation of the paging for the mobile terminals, to reduce overload in accordance with unnecessary paging, and to improve the performance of the system.

### INDUSTRIAL APPLICABILITY

In the traffic processing system and the method of processing the traffic, in processing the traffic for the mobile terminal, the plurality of apparatuses for processing the traffic are provided so that it is possible to effectively assign the IPs to the mobile terminals, to disperse the traffic, to minimize the generation of the paging for the mobile terminals, to reduce overload in accordance with unnecessary paging, and to improve the performance of the system.

1. A traffic processing system connected to a radio connection network comprising a plurality of evolved nodes to which mobile terminals are connected to process traffic for the mobile terminals, comprising:
mobility managing apparatuses connected to the plurality of evolved nodes to manage mobility and connection information on the mobile terminals;
a plurality of system architecture gateways for assigning IPs to the mobile terminals in accordance with request of the mobility managing apparatuses and for transmitting data packets for the mobile terminals; and
a load balance unit for transmitting data packets received from an IP network to one of the plurality of system architecture gateways.

2. The traffic processing system of claim 1, wherein the load balance unit stores information on data packets transmitted from a first system gateway to the IP network and information on the first system architecture gateway among the plurality of system architecture gateways and transmits the data packets received from the IP network to the predetermined first system architecture gateway based on the stored information.

3. The traffic processing system of claim 2, wherein the load balance unit transmits data packets to one of the plurality of system architecture gateways by a round robin method when information on the data packets received from the IP network does not exist.

4. The traffic processing system of claim 1, further comprising gateway managing units for transmitting data received from the mobility managing apparatuses to one of the plurality of system architecture gateways.

5. The traffic processing system of claim 4, wherein the gateway managing units transmit data to one of the plurality of system architecture gateways in response to an amount of traffic of the plurality of system architecture gateways.

6. The traffic processing system of claim 1, wherein the plurality of system architecture gateways initialize storage spaces for managing IP addresses using interface IDs and IP prefix information of the mobile terminals when services of the mobile terminals start and, when the mobility managing apparatuses request to assign addresses to the mobile terminals, assign the IP addresses to the mobile terminals using the interface IDs and the IP prefix information of the mobile terminals.

7. The traffic processing system of claim 6, wherein the system architecture gateways compare the IP prefix information on the mobile terminals with the IP addresses of the data packets when the data packets are received from the IP networks and, when the IP prefix information matches the IP addresses, request the mobility managing apparatuses to transmit paging for the data packets.

8. The traffic processing system of claim 7, wherein the system architecture gateways store only a first packet of the data packets during the paging request and, when bearers for the mobile terminals are generated in response to the paging request, transmit the stored first packet to the mobile terminals.

9. A method of processing traffic of a traffic processing system, comprising:
system architecture gateways initializing IP address storage spaces using interface IDs and IP prefix information for the mobile terminals;
receiving address assignment request for the mobile terminals from mobility managing apparatuses; and
assigning IP addresses to the mobile terminals using the interface IDs and the IP prefix information and transmitting the IP addresses to the mobility managing apparatuses.

10. The method of claim 9, wherein, in receiving address assignment request for the mobile terminals from mobility managing apparatuses, address assigning request of the mobility managing apparatuses is distributed by the gate managing units to the system architecture gateways in response to an amount of traffic processed by the system architecture gateways.

11. The method of claim 9, further comprising:
when data packets are received from an IP network to the mobile terminal, comparing the IP addresses of the data packets with the IP prefix information on the mobile terminal; and
when the IP prefix information matches the IP addresses of the data packets, paging for the data packets is requested by the mobility managing apparatuses.

12. The method of claim 11, wherein, in paging for the data packets is requested by the mobility managing apparatuses, only the first packet of the data packets is stored.

13. The method of claim 12, wherein, after paging for the data packets is requested by the mobility managing apparatuses, when a bearer for the mobile terminal is generated by the paging request, transmitting a first packet of the data packets to the mobile terminal.

14. The method of claim 11, further comprising abandoning the data packets when the IP prefix information is not the same as the IP addresses of the data packets.

15. A method of processing traffic of a traffic processing system, comprising:
when a first data packet of a mobile terminal is transmitted to an IP network by a first system gateway among a plurality of system architecture gateways, a load balance unit storing information on the first data packet; and
when a second data packet is received from the IP network to the mobile terminal in response to the first data pack, transmitting the second data packet to the first system gateway in accordance with the stored information.

16. The method of claim 15, wherein, in a load balance unit storing information on the first data packet, information on the first data packet transmitted to the IP network and information on the first system architecture gateway in which the first data packet is processed are stored.

17. The method of claim 15, wherein, when information corresponding to the second data packet does not exist, the second data packet is transmitted to one of the plurality of system architecture gateways by a round robin method.
